(19) United States
(12) Patent Application Publication
(10) Pub. No.: US 2021/0217023 A1
(43) Pub. Date: Jul. 15, 2021

(54) Secure financial settlement method and system of block chain

(71) Applicant: Yu Zhou, Shenzhen City (CN)

(72) Inventor: Yu Zhou, Shenzhen City (CN)

(21) Appl. No.: 16/907,288

(22) Filed: Jun. 21, 2020

(30) Foreign Application Priority Data
Jan. 9, 2020 (CN) 202010021663.7

(51) Int. Cl. G06Q 20/40; G06Q 20/36; G06Q 20/38; G06Q 20/06; G06Q 40/04; G06Q 40/02; G06F 16/23; H04L 29/06; G06N 3/02; G06K 9/00

(52) U.S. Cl. CPC G06Q 20/40145; G06Q 20/3676; G06Q 20/3674; G06Q 20/3678; G06Q 20/381; G06Q 20/065; G06Q 2220/00; G06Q 40/02; G06F 16/2379; H04L 63/0861; G06N 3/02; G06K 9/00288; G06Q 40/04

(57) ABSTRACT

The application provides a secure financial settlement method and system of blockchain, which is applied to the blockchain data system, the system comprises settlement node 1, settlement node 2, and data center. The technical solution relates to the application has the advantage of high security.

### CROSS-REFERENCE TO RELATED APPLICATION

This non-provisional patent application claims priority from Chinese Patent Application No. 202010021663.7 filed on Jan. 9, 2020, the entire of which is incorporated herein by reference.

### TECHNICAL FIELD

The application relates to the field of blockchain, specifically relates to a secure financial settlement method and system of blockchain.

### BACKGROUND

Blockchain is a new application model of distributed data storage, point-to-point transmission, consensus mechanism, encryption algorithm, and other computer technologies. It refers especially to a series of text records (also known as blocks) that are concatenated and protected by cryptography, each block contains the encrypted hashes, corresponding timestamps and, transaction data of the previous block, this design makes the block content difficult to tamper with. Distributed ledgers linked by blockchain technology can effectively record transactions and permanently examine them.

The financial settlement means the settlement of commodities through currency, the term “currency” refers especially to the currency issued or authorized by the People's Bank of China. The security verification of the financial settlement of the existing blockchain is based on the account number and password, and this settlement method cannot guarantee the security of the financial settlement of the blockchain, so the financial settlement of the existing blockchain is not secure.

### SUMMARY

The disclosed embodiment is intended to provide a secure financial settlement method and device for blockchain, and the technical solution can improve the security of the blockchain.

One of the disclosed embodiments provides a secure financial settlement method of blockchain, the method is applied to the blockchain data system, comprising:

settlement node 1 collects the facial image of the target object, and obtains the financial settlement data of account number 1 logged in by the target object, and according to the blockchain transaction format packages the financial settlement data and facial image into transactions to be confirmed, settlement node 1 sends the transactions to the data center to be confirmed;

data center obtains the financial settlement data and facial image in the transaction to be confirmed, according to the facial image to verify its first identify, and confirm the match between the first identify and account number 1 identification, the data center inquires whether the balance of the secondary token of account number 1 is greater than the amount of the secondary token of the financial settlement data;

when the data center determines that the balance of account number 1 is greater than the amount of financial settlement data, the amount of the secondary token in account number 1 is transferred to account number 2, and the on-chain cost of the secondary token is deducted from the balance of account number 1, the data center converts the on-chain cost into the data currency; the data center sends transaction records and data currency to settlement node 2;

settlement node 2 records the transactions of the financial settlement in the blockchain:

according to the facial image to verify its first identify, and confirm the match between the first identify and account number 1 identification, comprising:

the first input data is generated based on the facial image, and the first input data will be performed with the multi-layer convolution operation of the neural network to obtain the operation result of matrix, the feature map of the result of matrix is obtained by preserving the element values in the result of matrix which are greater than the characteristic threshold, the adjacent elements in the feature map are set as the feature area, and the number of elements in the feature area is greater than the quantity threshold, and the central location of each feature area is extracted, the center position of all feature areas is connected with a straight line to obtain the feature curve, which is compared with the template curve of the preset face template of Account 1 to determine whether the feature curve is similar to some areas in the template curve, if the characteristic curve is similar to part of the template curve, then the first identity is determined corresponding to the identity of account number 1; if the feature area is determined different from all parts of the template area, then the first identity is determined non-corresponding to the identity of account number 1.

One of the disclosed embodiments provides a blockchain data system, comprising:

settlement node 1 is used to collect the facial image of the target object, to obtain the financial settlement data of account number 1 logged in by the target object, and to package the financial settlement data and facial image into transactions to be confirmed according to the blockchain transaction format, sending the transactions to the data center to be confirmed;

data center is used to obtain the financial settlement data and facial image in the transaction be confirmed, according to the facial image to verify its first identify, and confirm the match between the first identify and account number 1 identification, the data center inquires whether the balance of the secondary token of account number 1 is greater than the amount of the secondary token of the financial settlement data; when the data center determines the balance of account number 1 is greater than the amount of financial settlement data, the amount of the secondary token in account number 1 is transferred to account number 2, and the on-chain cost of the secondary token is deducted from the balance of account number 1, the data center converts the on-chain cost into the data currency; the data center sends transaction records and data currency to settlement node 2;

settlement node 2 is used to record the financial settlement transactions on the blockchain;

the data center is specifically used to generate the first input data according to the face image, and the first input data will be performed with the multi-layer convolution operation of the neural network to obtain the operation result of matrix, the feature map of the result of matrix is obtained by preserving the element values in the result of matrix which are greater than the characteristic threshold, the adjacent elements in the feature map are set as the feature area, and the number of elements in the feature area is greater than the quantity threshold, and the central location of each feature area is extracted, the center position of all feature areas is connected with a straight line to obtain the feature curve, which is compared with the template curve of the preset face template of Account 1 to determine whether the feature curve is similar to some areas in the template curve, if the characteristic curve is similar to part of the template curve, then the first identity is determined corresponding to the identity of account number 1; if the feature area is determined different from all parts of the template area, then the first identity is determined non-corresponding to the identity of account number 1.

The disclosed embodiment provides a computer-readable storage medium for storing a computer program for the exchange of electronic data in which the computer program enables the computer to perform the method provided in the first place.

This application provides a financial settlement method to settle at acquisition target facial images, which to the account name and password of login account number 1, also need to collect facial images to confirm the identity of the target object, then, the data center verifies the identity of account number land the facial image, If confirmed to be consistent, the financial settlement is processed, and avoid the target object unrelated to account number 1 from stealing the password of account number 1 to conduct financial settlement on the data currency of account number 1, thus improving the security of financial settlement.

### BRIEF DESCRIPTION OF DRAWINGS

To more clearly explains application implementation examples of the technical scheme, the following will need to be used in the implementation of case description were illustrated introduce simply and clearly, the appended drawings described below are some of the implementation of the application example, for ordinary technicians in this field, other appended drawings can be obtained based on these appended drawings without creative efforts.

FIG. 1 is a structural diagram of a blockchain data system provided for this open embodiment.

FIG. 1a is a structural diagram of an electronic device provided for this open embodiment.

FIG. 2 is the flow diagram of a secure financial settlement method of blockchain in this open embodiment.

FIG. 2a is a process diagram of the operation results provided by this open embodiment.

FIG. 2b is a schematic diagram of the characteristic curve provided for this open embodiment.

FIG. 2c is a schematic diagram of the slope template vector provided for this open embodiment.

### DESCRIPTION OF EMBODIMENTS

The following is a clear and complete description of the technical scheme, a clear and complete description of the technical solution is this application embodiment, the described embodiments are part of the embodiments of this application, but not all of them. Based on embodiments in this application, all other embodiments obtained by ordinary technicians in this field without creative labor would be covered by this application.

The terms “first”, “second”, “third” and “fourth” in the description, claim of this application and the appended drawings are used to distinguish different objects, but not to describe a particular order. Also, the terms “include” and “have”, and any deformation of those words are intended to override non-exclusive inclusions. For example, a series of steps or unit process, method, system, product, or device is not limited to the listed steps or units, but optionally includes steps or units that are not listed, or optionally includes other steps or units that are inherent to those processes, methods, products, or devices.

The reference to “embodiments” in this context implies that the specific characteristics, structures, or characteristics described in combination with the embodiments may be included in at least one embodiment of this application. The appearance of the phrase in various places in the specification does not necessarily refer to the same embodiment, nor is it an independent or alternative embodiment mutually exclusive with other embodiments. It is understood explicitly and implicitly by the technical person in the field that the embodiments described herein can be combined with other embodiments.

A smart contract is a program or script with a specific function that is recorded on the blockchain and guaranteed to be unique by the tamper-proof features of the.

An account, or wallet, is a cryptographically generated combination of keys and addresses. The user obtains access to the corresponding account on the blockchain by using the key. Digital currency refers to the currency to be issued by the People's Bank of China (PBOC) applied to the blockchain, of course, the digital currency could also be other online currencies that can be exchanged with the currencies issued by the PBOC, such as QQ coin, timecard and so on.

In the current blockchain, when users initiate financial settlement, they need to chain the transaction of the financial settlement, at this time, a certain currency needs to be submitted to the transaction chain after the transaction party is determined, the fee of financial settlement will be recorded from account A to account B. Transaction chain refers to the upload of a transaction (a certain amount of data) to the public blockchain.

For example, take the transaction chain of digital currency transfer as an example. If the financial settlement is the score of a cinema, user A transfers 1000 points to user B, if user A needs to transfer on block chain, the user needs to pay certain amount of digital currency as service fee, such as one QQ coin or one digital currency (issued by the people's bank of China). When user A needs to initiate a financial calculation on the blockchain, he must have QQ coins or digital currency in his account. User A will need to log into account A corresponding to user A and enter the password of account A for the transaction of the financial settlement. Account A is generally a mailbox, and the input password is the input password of the mailbox. The financial settlement of the existing blockchain is based on the security of account numbers and passwords are not high.

The following is the principle of blockchain, actually a blockchain is a data link, anyone can upload data in the blockchain. Financial settlement is also a kind of data upload, but the data upload requires a certain price, which is realized through digital currency (namely the currency issued by the people's bank of China). The reason for using digital currency is to avoid data paralysis or data explosion on the blockchain. Take the current public chain network as an example, at present, the acquisition of digital currency must be involve related costs. For example, Bitcoin needs to waste electricity fees and the digital currency needs to be exchanged with real currency, in which case it cannot be freely available. Therefore, if user A wants to execute a financial settlement in blockchain, which is upload the financial settlement data. Based on the size of the uploaded data, it needs to pay a part of bitcoin or the cost of digital currency. For the secondary token, it can be created by anyone (the currency has limitations, such as stor points, bank points, and so on all belong to secondary tokens) which can not cost that can realize secondary tokens can be realized. If the chain operation can be realized by paying secondary tokens, then the user can execute the chain operation without any cost, which will inevitably lead to the explosion of the entire blockchain. Besides, the secondary token can be only used for financial settlement with the approval of the secondary token, such as the points of China Merchants Bank cannot be used in the Bank of Communications. Moreover, the security of the financial settlement method is also low.

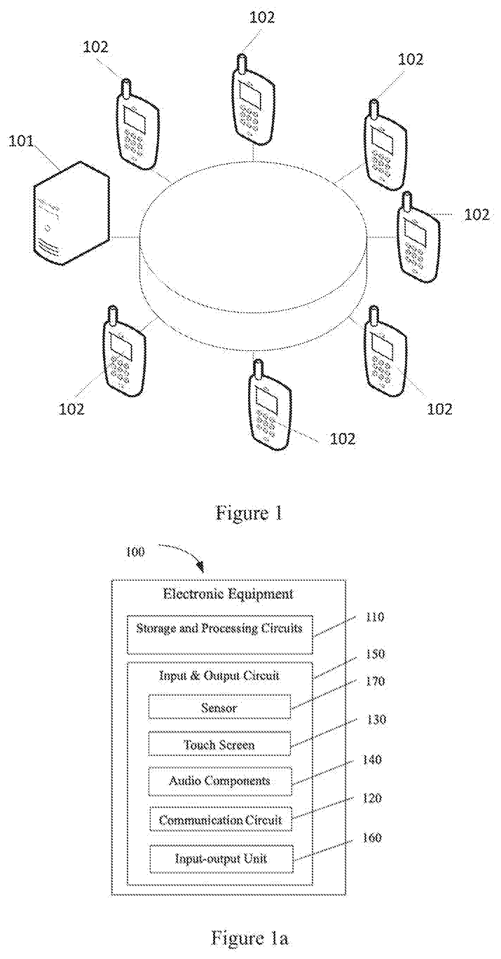

Refer to FIG. 1, it provides a blockchain data system, as shown in FIG. 1, the blockchain data system can include: data center 101 and multiple settlement nodes 102, among them, the multiple settlement nodes 102 and the data center 101 communicate and form a blockchain.

The data center 101 in this application can be a cloud platform, server center, etc. The multiple computing nodes 102 described above might be electronic devices which can refer to FIG. 1a, that is a schematic diagram of an electronic device disclosed in this application embodiment, the electronic device 100 includes a storage and processing circuit 110, and a sensor 170 connected to the storage and processing circuit 110, including:

The electronic device 100 may include a control circuit, which may includes a storage and processing circuit 110. The storage and processing circuit 110 can be a memory, such as hard disk drive memory, non-volatile memory (such as the flash memory or other electronic programmable read-only memory used to form a solid-state drive, etc.), and volatile memory (such as static or dynamic random-access memory, etc.), there is no limitation made in this application embodiment. The processing circuit in the storage and processing circuit 110 may be used to control the operation of the electronic device 100. The processing circuit may be implemented based on one or more microprocessor, microcontrollers, digital signal processors, baseband processors, power management units, audio codec chips, special-purpose integrated circuits, display driver integrated circuits, etc.

The storage and processing circuit 110 might be used to run the software in the electronic device 100, such as internet browsing applications, Voice over Internet Protocol (VOIP) telephone calling applications, E-mail applications, media playback applications, and operating systems functions, etc. This software can be used to execute some control operations, such as image acquisition based on camera, ambient light measurement based on ambient light sensor, proximity sensor measurement based on proximity sensor, information display based on state indicators such as light emitting diodes, touch event detection based on touch sensors, and functions associated with displaying information on multiple (for example, layered) displays. Also, the operations associated with performing wireless communications functions, the operations associated with collecting and generating audio signals, the control operations associated with collecting and processing button press event data, and other functions in electronic equipment 100 are not restricted in this application embodiment.

The electronic device 100 may include an input-output circuit 150. The input-output circuit 150 can be used to enable the electronic device 100 to achieve data input and output, that is, to allow the electronic device 100 to receive data from an external device and also to allow the electronic device 100 to export data to an external device. The input-output circuit 150 may further include a sensor 170. The sensor 170 may include an ultrasonic fingerprint recognition module. The ultrasonic sensor can also include an ambient light sensor, based on the optical and capacitance proximity sensor, and a touch sensor (for example, based on light touch sensors and/or capacitive touch sensor, among them, the touch sensor can be part of the touch display screen, can also be used independently as a touch sensor structure), acceleration sensors, and other sensors, the ultrasonic fingerprint recognition module can be integrated in the bottom of the screen, or the ultrasonic fingerprint recognition module can be set on the side or back of the electronic device, which is not limitation here. The ultrasonic fingerprint recognition module can be used to collect fingerprint images.

The sensor 170 may include an infrared (IR) camera or an RGB camera. When the IR camera is shooting, the pupil reflects infrared light, so the IR camera will capture the pupil image more accurately than the RGB camera; The RGB camera needs more subsequent image processing and calculation. The precision and accuracy are higher than IR cameras, and the versatility is better than IR cameras, but the calculation is large.

The input-output circuit 150 may also include one or more display screens, such as display screen 130. The display screen 130 may include a liquid crystal display (LCD) screen, an organic light-emitting diode (OLED) display screen, an e-ink plasma display screen, and one or a combination of several display screens using other display technologies. The display screen 130 may include an array of touch sensor (such as the display screen 130 may be a touch display screen). Touch sensors can be by transparent touch sensor electrode (such as indium tin oxide (ITO) electrode) form of capacitive touch sensors array, or you can use other touch technology form of touch sensors, such as sonic touch, pressure-sensitive touch, resistive touch, such as optical touch, there is no limitation in this application cases.

The electronic device 100 may also include an audio component 140. The audio component 140 may be used to provide audio input and output functions for the electronic device 100. The audio component 140 in the electronic device 100 include speakers, microphones, buzzers, tone generators, and other components used to produce and detect sound.

The communication circuit 120 can be used to provide the electronic device 100 with the ability to communicate with external devices. The communication circuit 120 may include analog and digital input-output interface circuits, and wireless communication circuits based on radio frequency signals and/or optical signals. The wireless communication circuit in the communication circuit 120 may include a radio frequency transceiver circuits, power amplifier circuits, low noise amplifiers, switches, filters, and antennas. For example, the wireless communication circuit in the communication circuit 120 may include a circuit for supporting Near Field Communication (NFC) by transmitting and receiving near-field coupled electromagnetic signals. Moreover, the communication circuit 120 may include a near-field communication antenna and a near-field communication transceiver. The communication circuit 120 may also include a cellular phone transceiver and antenna, a wireless local area network transceiver circuit and antenna, etc.

The electronic device 100 can further include batteries, power management circuits, and other input-output units 160. The input-output unit 160 may include buttons, joysticks, click wheels, scroll wheels, touchpads, keypads, keyboards, cameras, light-emitting diode, and other status indicators.

The user can control the operation of the electronic device 100 through the input-output circuit 150 input command, and the output data of the input-output circuit 150 can be used to receive the status information and other output from the electronic device 100.

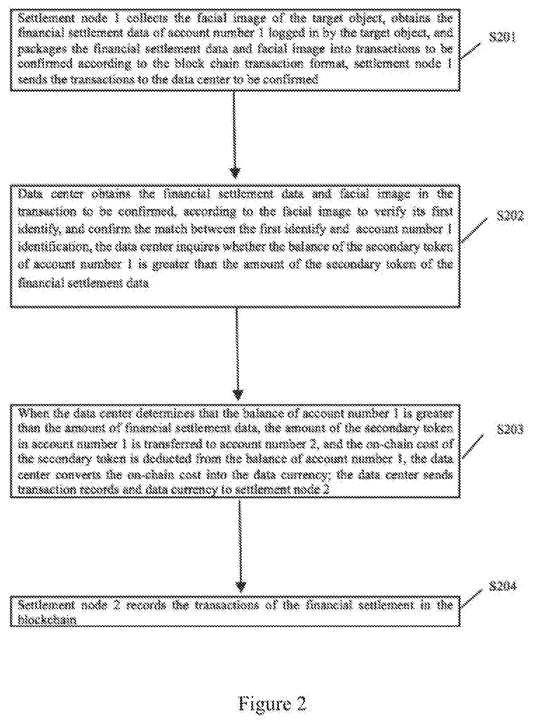

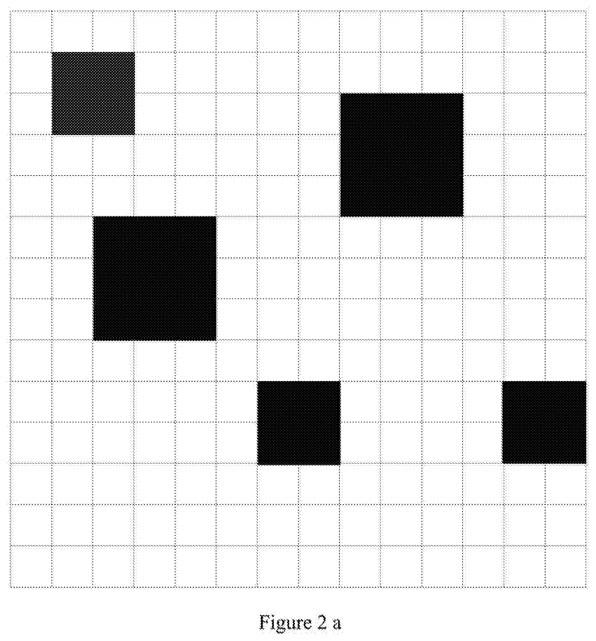

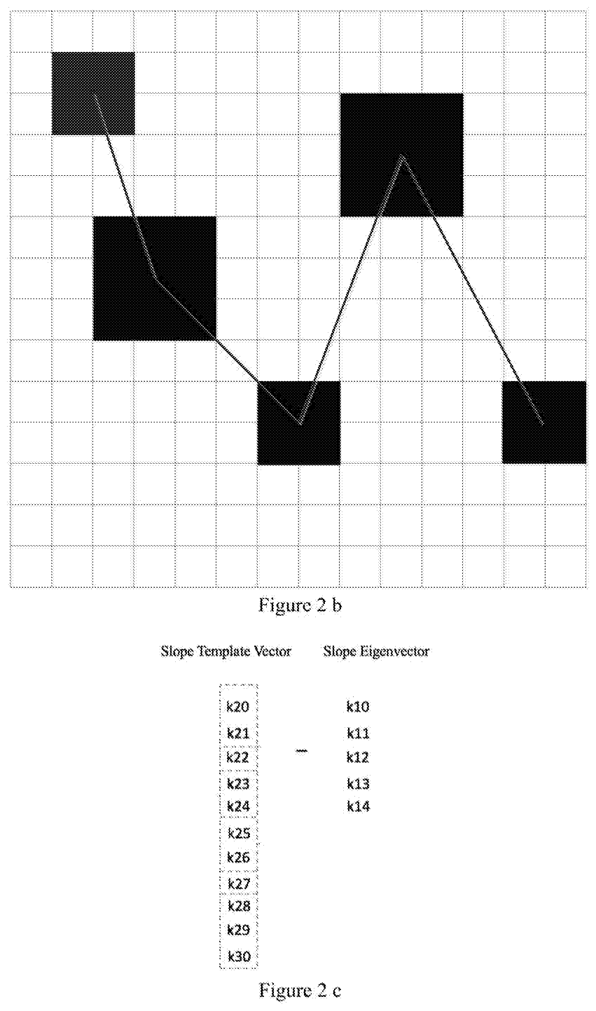

Refer to FIG. 2, it provides a secure financial settlement method of blockchain, the method is shown in FIG. 2 and can be executed by the blockchain data system shown in FIG. 1, the method is shown in FIG. 2, including the following steps:

Step S201: Settlement node 1 collects the facial image of the target object, obtains the financial settlement data of account number 1 logged in by the target object, and packages the financial settlement data and facial image into transactions to be confirmed according to the blockchain transaction format, settlement node 1 sends the transactions to the data center to be confirmed.

The settlement node 1 described above can be an electronic device in the blockchain, and the specific structure of the electronic device can be shown in FIG. 1a.

Step S202: Data center obtains the financial settlement data and facial image in the transaction to be confirmed, according the facial image to verify its first identify, and confirm the match between the first identify and account number 1 identification, the data center inquires whether the balance of the secondary token of account number 1 is greater than the amount of the secondary token of the financial settlement data.

The data center described above can be the server of the secondary token provider, using credit card points of China Merchants Bank (CMBC) as a secondary token example, its data center can be the center of credit card points of CMBC.

For the data center, its identity information with account number 1 is required to add the data center to the blockchain, but for the provider of secondary tokens, if account number 1 has secondary tokens (such as bank credit points of CMBC), then the account number 1 must be a CMBC user, which the CMBC must have the corresponding information of the user, therefore, the facial recognition can be realized for the identity of account number 1.

Step S203: When the data center determines that the balance of account number 1 is greater than the amount of financial settlement data, the amount of the secondary token in account number 1 is transferred to account number 2, and the on-chain cost of the secondary token is deducted from the balance of account number 1, the data center converts the on-chain cost into the data currency; the data center sends transaction records and data currency to settlement node 2.

Step S204: Settlement node 2 records the transactions of the financial settlement in the blockchain.

The transaction records above include but are not limited to: account number 1, account number 2, the number of secondary tokens, the transaction time, the transaction goods, etc.

The transaction time above includes but is not limited to: login time of account number 1, the launch time of the transaction to be confirmed for account number 2, transaction record sending time of data center, etc.

The above settlement node 2 can be the transaction confirmation party of blockchain. The settlement node 1 can be the transaction initiator of the blockchain.

This application provides a financial settlement method to settle at acquisition target facial images, which to the account name and password of login account number 1, also need to collect facial images to confirm the identity of the target object, then, the data center verifies the identity of account number land the facial image, If confirmed to be consistent, the financial settlement is processed, and avoid the target object unrelated to account number 1 from stealing the password of account number 1 to conduct financial settlement on the data currency of account number 1, thus improving the security of financial settlement.

Alternatively, the methods described above are also comprised:

The data center determines that the first identity is non-corresponding to the identity of account number 1 and closes the financial settlement.

If the first identity is not in accordance with the identity of account number 1, it means that the operator of account 1 is not the actual owner, so the financial settlement should be closed to avoid unnecessary losses of account number 1, the described method also includes: the data center will send the closed financial settlement to the binding terminal of account number 1.

Optionally, the facial image is verified to determine the first identity of the facial image, and determine the first identity is corresponding to the identity of account number 1, including:

The first input data is generated based on the facial image, such as facial images of each pixel gray value or RGB value, and the first input data will be performed with the multi-layer convolution operation of the neural network to obtain the result matrix, the feature map of the result matrix is obtained by preserving the element values in the result matrix which are greater than the characteristic threshold, (as shown in FIG. 2a, each box represents an element, the black box is greater than the threshold features of the element value), the adjacent elements in the feature map are set as the feature area, as shown in FIG. 2a black area, and the number of elements in the feature area is greater than the quantity threshold, and the number of elements in the feature area is greater than the quantity threshold, and the central location of each feature area is extracted, the center position of all feature areas is connected with a straight line to obtain the feature curve, as shown in FIG. 2b, which is compared with the template curve of the preset face template of Account 1 to determine whether the feature curve is similar to some areas in the template curve, if the characteristic curve is similar to part of the template curve, then the first identity is determined corresponding to the identity of account number 1; if the feature area is determined different from all parts of the template area, then the first identity is determined non-corresponding to the identity of account number 1.

Optionally, the characteristic curve is compared with the template curve of the preset facial template of account 1 to determine whether the characteristic curve is similar to part of the template curve, including:

To extract the characteristic curve in each period of the straight line of the slope, and the slope is composed into the feature vector of the slope in order, and to extract the template curve in each period of the straight line of the slope, and the slope is composed into the slope template vector in order, the partial vectors with the same size as the slope feature vectors are extracted from the slope template vectors in order, (the dotted line is shown in FIG. 2c), and to calculate the difference between each partial vector and the slope feature vector to get multiple difference values (As shown in FIG. 2c, 7 partial vectors can be extracted, which means 7 differences can be got through calculation), and to extract the minimum value of multiple difference values, if the minimum value is greater than the similarity threshold, the characteristic curve is not similar to the part of areas in the template curve, if the minimum value is less than or equal to the similarity threshold, the characteristic curve is compared with the template curve of the preset facial template of account number 1 to determine that the characteristic curve is similar to part of areas in the template curve.

The difference between the facial recognition of this application and the existing one is, that the technical scheme of this application can realize the facial recognition of partial areas. In the scene of facial recognition, there is a high requirement for template image collection, so it contains all feature information of the human face. However, for the collection of facial images, it may be only part of the facial images collected due to the angle of the camera to collect or target objects, and the accuracy of comparison between the part of the facial images and the template images is very poor, in this regard, the applicant analyzed and determined the operation results of the neural network and obtained the following features. Since part of the facial image and the template facial image belong to the same person, so the features of part of the facial images are only part of the features of the template facial image, such as “moles”, “eyes”, “face contour” and so on, after these features are calculated, the trend of the convolution operation results is always similar, but if there are few similar results, the smaller similar part will be weakened after the full-connection operation of the existing neural network model, and the comparison cannot be realized, however, the application scheme is determined based on convolution operation result to compare directly, and its characteristic curve and is compared with several regions of the template curve, even has fewer features, it also can achieve recognition results, so the application of technology solutions can weaken the angle of the camera collection to improving the accuracy of facial recognition.

This application also provides a blockchain data system, which includes settlement node 1 and settlement node 2, and a data center;

Settlement node 1 is used to collect the facial image of the target object, to obtain the financial settlement data of account number 1 logged in by the target object, and to package the financial settlement data and facial image into transactions to be confirmed according to the blockchain transaction format, sending the transactions to the data center to be confirmed;

The data center is used to obtain the financial settlement data and facial image in the transaction be confirmed, according to the facial image to verify its first identify, and confirm the match between the first identify and account number 1 identification, the data center inquires whether the balance of the secondary token of account number 1 is greater than the amount of the secondary token of the financial settlement data; when the data center determines the balance of account number 1 is greater than the amount of financial settlement data, the amount of the secondary token in account number 1 is transferred to account number 2, and the on-chain cost of the secondary token is deducted from the balance of account number 1, the data center converts the on-chain cost into the data currency; the data center sends transaction records and data currency to settlement node 2;

Settlement node 2 is used to record the financial settlement transactions on the blockchain;

the data center is specifically used to generate the first input data according to the face image, and the first input data will be performed with the multi-layer convolution operation of the neural network to obtain the operation result of matrix, the feature map of the result of matrix is obtained by preserving the element values in the result of matrix which are greater than the characteristic threshold, the adjacent elements in the feature map are set as the feature area, and the number of elements in the feature area is greater than the quantity threshold, and the central location of each feature area is extracted, the center position of all feature areas is connected with a straight line to obtain the feature curve, which is compared with the template curve of the preset face template of Account 1 to determine whether the feature curve is similar to some areas in the template curve, if the characteristic curve is similar to part of the template curve, then the first identity is determined corresponding to the identity of account number 1; if the feature area is determined different from all parts of the template area, then the first identity is determined non-corresponding to the identity of account number 1.

This application provides a financial settlement method to settle at acquisition target facial images, which to the account name and password of login account number 1, also needs to collect facial images to confirm the identity of the target object, then the data center verifies the identity of account number 1 and the facial image, if confirmed to be consistent, the financial settlement is processed, and avoid the target object unrelated to account number 1 from stealing the password of account number 1 to conduct financial settlement on the data currency of account number 1, thus improving the security of financial settlement.

Optionally, the data center is specially used to extract the characteristic curve in each period of the straight line of the slope, and the slope is composed into the feature vector of the slope in order, and to extract the template curve in each period of the straight line of the slope, and the slope is composed into the slope template vector in order, the partial vectors with the same size as the slope feature vectors are extracted from the slope template vectors in order, and to calculate the difference between each partial vector and the slope feature vector to get multiple difference values, and to extract the minimum value of multiple difference values, if the minimum value is greater than the similarity threshold, the characteristic curve is not similar to part of areas in the template curve, if the minimum value is less than or equal to the similarity threshold, the characteristic curve is compared with the template curve of the preset facial template of account number 1 to determine that the characteristic curve is similar to part of areas in the template curve.

Optionally, the data center is also used to determine that the first identity is non-corresponding to the identity of account number 1 and close the financial settlement.

Optionally, the data center is also used to send the closed financial settlement to the bound terminal of account number 1.

The application provides a computer-readable storage medium, the medium is used to store a computer program for the exchange of electronic data, the computer program causes the computer to execute the method provided in FIG. 2.

The above embodiments of this application are introduced in detail, in this paper, the description of the above embodiments is intended only used to help to understand of the methods and core ideas of this application; At the same time, for the ordinary technical personnel in this field, according to the idea of this application, there will be some changes in the specific implementation method and application scope, in summary, the content of this specification should not be construed as a limitation of this application.

1. A secure financial settlement method of blockchain, the method is applied to the blockchain data system, comprising:
settlement node 1 collects the facial image of the target object, and obtains the financial settlement data of account number 1 logged in by the target object, and according to the blockchain transaction format packages the financial settlement data and facial image into transactions to be confirmed, settlement node 1 sends the transactions to the data center to be confirmed;
data center obtains the financial settlement data and facial image in the transaction to be confirmed, according to the facial image to verify its first identify, and confirm the match between the first identify and account number 1 identification, the data center inquires whether the balance of the secondary token of account number 1 is greater than the amount of the secondary token of the financial settlement data;
when the data center determines that the balance of account number 1 is greater than the amount of financial settlement data, the amount of the secondary token in account number 1 is transferred to account number 2, and the on-chain cost of the secondary token is deducted from the balance of account number 1, the data center converts the on-chain cost into the data currency; the data center sends transaction records and data currency to settlement node 2;
settlement node 2 records the transactions of the financial settlement in the blockchain:
according to the facial image to verify its first identify, and confirm the match between the first identify and account number 1 identification, comprising:
the first input data is generated based on the facial image, and the first input data will be performed with the multi-layer convolution operation of the neural network to obtain the operation result of matrix, the feature map of the result of matrix is obtained by preserving the element values in the result of matrix which are greater than the characteristic threshold, the adjacent elements in the feature map are set as the feature area, and the number of elements in the feature area is greater than the quantity threshold, and the central location of each feature area is extracted, the center position of all feature areas is connected with a straight line to obtain the feature curve, which is compared with the template curve of the preset face template of Account 1 to determine whether the feature curve is similar to some areas in the template curve, if the characteristic curve is similar to part of the template curve, then the first identity is determined corresponding to the identity of account number 1; if the feature area is determined different from all parts of the template area, then the first identity is determined non-corresponding to the identity of account number 1.

2. The method according to claim 1, wherein the characteristic curve is compared with the template curve of the preset facial template of account 1 to determine whether the characteristic curve is similar to part of the template curve, comprising:
extracting the characteristic curve in each period of the straight line of slope, and the slope is composed into the feature vector of the slope in order;
extracting the template curve in each period of the straight line of the slope, and the slope is composed into the slope template vector in order, the partial vectors with the same size as the slope feature vectors are extracted from the slope template vectors in order;
calculating the difference between each partial vector and the slope feature vector to get multiple difference values;
extracting the minimum value of multiple difference values, if the minimum value is greater than the similarity threshold, the characteristic curve is not similar to part of areas in the template curve, if the minimum value is less than or equal to the similarity threshold, the characteristic curve is compared with the template curve of the preset facial template of account number 1 to determine that the characteristic curve is similar to part of areas in the template curve.

3. The method according to claim 1, wherein the method further comprising:
the data center determines that the first identity is non-corresponding to the identity of account number 1 and closes the financial settlement.

4. The method according to claim 3, wherein the method further comprising:
the data center sends the closed financial settlement to the bound terminal of account number 1.

5. A blockchain data system, comprising:
settlement node 1 is used to collect the facial image of the target object, to obtain the financial settlement data of account number 1 logged in by the target object, and to package the financial settlement data and facial image into transactions to be confirmed according to the blockchain transaction format, sending the transactions to the data center to be confirmed;
data center is used to obtain the financial settlement data and facial image in the transaction be confirmed, according to the facial image to verify its first identify, and confirm the match between the first identify and account number 1 identification, the data center inquires whether the balance of the secondary token of account number 1 is greater than the amount of the secondary token of the financial settlement data; when the data center determines the balance of account number 1 is greater than the amount of financial settlement data, the amount of the secondary token in account number 1 is transferred to account number 2, and the on-chain cost of the secondary token is deducted from the balance of account number 1, the data center converts the on-chain cost into the data currency; the data center sends transaction records and data currency to settlement node 2;
settlement node 2 is used to record the financial settlement transactions on the blockchain;
the data center is specifically used to generate the first input data according to the face image, and the first input data will be performed with the multi-layer convolution operation of the neural network to obtain the operation result of matrix, the feature map of the result of matrix is obtained by preserving the element values in the result of matrix which are greater than the characteristic threshold, the adjacent elements in the feature map are set as the feature area, and the number of elements in the feature area is greater than the quantity threshold, and the central location of each feature area is extracted, the center position of all feature areas is connected with a straight line to obtain the feature curve, which is compared with the template curve of the preset face template of Account 1 to determine whether the feature curve is similar to some areas in the template curve, if the characteristic curve is similar to part of the template curve, then the first identity is determined corresponding to the identity of account number 1; if the feature area is determined different from all parts of the template area, then the first identity is determined non-corresponding to the identity of account number 1.

6. The system according to claim 5, the data center is specially used to extract the characteristic curve in each period of straight line of slope, and the slope is composed into the feature vector of the slope in order; the data center is used to extract the template curve in each period of straight line of slope, and the slope is composed into the slope template vector in order, the partial vectors with the same size as the slope feature vectors are extracted from the slope template vectors in order; and the data center is used to calculate the difference between each partial vector and the slope feature vector to get multiple difference values, and the data center is used to extract the minimum value of multiple difference values, if the minimum value is greater than the similar threshold, the characteristic curve is not similar to part of areas in the template curve, if the minimum value is less than or equal to the similar threshold, the characteristic curve is compared with the template curve of the preset facial template of account number 1 to determine that the characteristic curve is similar to part of areas in the template curve.

7. The system according to claim 5, the data center is also used to determine that the first identity is non-corresponding to the identity of account number 1 and close the financial settlement.

8. The system according to claim 7, the data center is also used to send the closed financial settlement to the bound terminal of account number 1.

9. A computer-readable storage medium, the medium is used to store a computer program for the exchange of electronic data, the computer program enables the computer to perform the method described in the claim 1.

10. The computer-readable storage medium, the medium is used to store a computer program for the exchange of electronic data, the computer program enables the computer to perform the method described in the claim 2.

11. The computer-readable storage medium, the medium is used to store a computer program for the exchange of electronic data, the computer program enables the computer to perform the method described in the claim 3.

12. The computer-readable storage medium, the medium is used to store a computer program for the exchange of electronic data, the computer program enables the computer to perform the method described in the claim 4.
